(19) United States
(12) Patent Application Publication
(10) Pub. No.: US 2025/0234260 A1
(43) Pub. Date: Jul. 17, 2025

(54) COMMUNICATION CONTROL METHOD

(71) Applicant: KYOCERA Corporation, Kyoto (JP)

(72) Inventors: Masato FUJISHIRO, Yokohama-shi (JP); Henry CHANG, San Diego, CA (US); Mitsutaka HATA, Yokohama-shi (JP)

(73) Assignee: KYOCERA Corporation, Kyoto (JP)

(21) Appl. No.: 19/169,753

(22) Filed: Apr. 3, 2025

Related U.S. Application Data
(63) Continuation of application No. PCT/JP2023/035824, filed on Oct. 2, 2023.
(60) Provisional application No. 63/413,317, filed on Oct. 5, 2022.

(51) Int. Cl. H04W 36/08; H04W 36/32; H04W 84/06

(52) U.S. Cl. CPC H04W 36/08; H04W 36/328; H04W 84/06

(57) ABSTRACT

In an aspect, a communication control method is a communication control method in a mobile communication system. The communication control method includes a step of changing, by a user equipment, a frequency priority of a frequency to be used in a cell reselection procedure depending on an altitude of the user equipment.

### RELATED APPLICATIONS

The present application is a continuation based on PCT Application No. PCT/JP2023/035824, filed on Oct. 2, 2023, which claims the benefit of U.S. Provisional Patent Application No. 63/413,317 filed on Oct. 5, 2022. The content of which is incorporated by reference herein in their entirety.

### TECHNICAL FIELD

The present disclosure relates to a communication control method in a mobile communication system.

### BACKGROUND

In the specifications of the Third Generation Partnership Project (3GPP), which is a standardization project for mobile communication systems, an Aerial UE is defined (for example, see Non-Patent Document 1 and Non-Patent Document 2). For example, the Aerial UE can report an altitude or report position information including a vertical velocity and a horizontal velocity. In the 3GPP, communication with the Aerial UE flying in the sky is appropriately supported through such specifications.

### CITATION LIST

### Non-Patent Literature

Non-Patent Document 1: 3GPP TS 36.300 V17.1.0 (2022-6)
Non-Patent Document 2: 3GPP TS 36.331 V17.1.0 (2022-6)

### SUMMARY

In an aspect, a communication control method is a communication control method in a mobile communication system. The communication control method includes a step of changing, by a user equipment, a frequency priority of a frequency used in a cell reselection procedure depending on an altitude of the user equipment.

In an aspect, a communication control method is a communication control method in a mobile communication system. The communication control method includes a step of transmitting, by a network node (or a network apparatus), a tracking area code identifying a tracking area formed at an altitude equal to or higher than an altitude threshold value.

### BRIEF DESCRIPTION OF THE DRAWINGS

FIG. 1 is a diagram illustrating a configuration example of a mobile communication system according to a first embodiment.

FIG. 2 is a diagram illustrating a configuration example of a User Equipment (UE) according to the first embodiment.

FIG. 3 is a diagram illustrating a configuration example of a gNB (base station) according to the first embodiment.

FIG. 4 is a diagram illustrating a configuration example of a protocol stack of a user plane according to the first embodiment.

FIG. 5 is a diagram illustrating a configuration example of a protocol stack of a control plane according to the first embodiment.

FIG. 6 is a diagram illustrating a cell configuration example according to the first embodiment.

FIG. 7 is a diagram illustrating an operation example according to the first embodiment.

FIG. 8 is a diagram illustrating an operation example according to a second embodiment.

FIG. 9 is a diagram illustrating an operation example according to a third embodiment.

FIG. 10 is a diagram illustrating an operation example according to a fourth embodiment.

### DESCRIPTION OF EMBODIMENTS

A mobile communication system according to an embodiment is described with reference to the drawings. In the description of the drawings, the same or similar parts are denoted by the same or similar reference signs.

### First Embodiment

### Configuration of Mobile Communication System

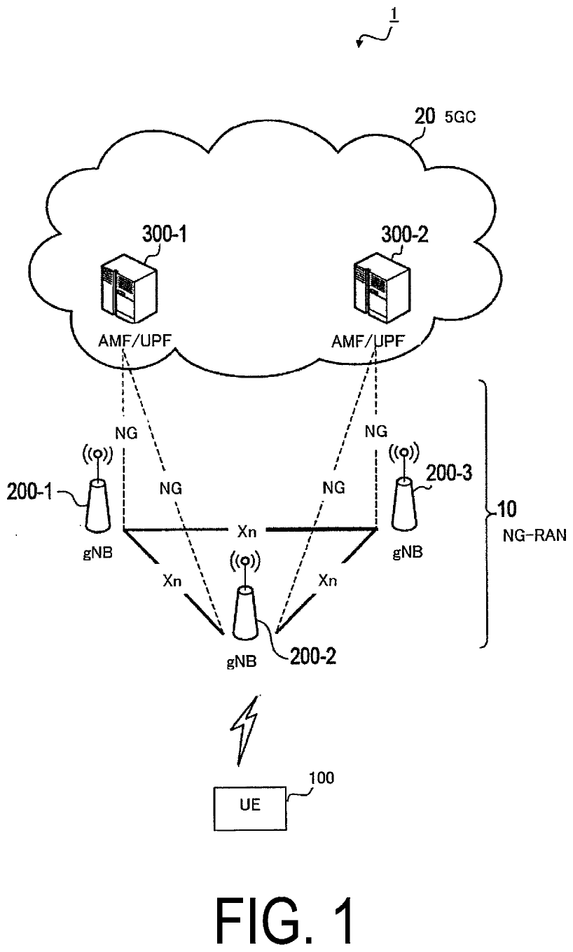

FIG. 1 is a diagram illustrating a configuration of a mobile communication system according to a first embodiment. The mobile communication system 1 complies with the 5th Generation System (5GS) of the 3GPP standard. The description below takes the 5GS as an example, but Long Term Evolution (LTE) system may be at least partially applied to the mobile communication system. Alternatively, a sixth generation (6G) system may be at least partially applied to the mobile communication system.

The mobile communication system 1 includes User Equipment (UE) 100, a 5G radio access network (Next Generation Radio Access Network (NG-RAN)) 10, and a 5G Core Network (5GC) 20. The NG-RAN 10 will be hereinafter simply referred to as the RAN 10. The 5GC 20 may be simply referred to as the Core Network (CN) 20.

The UE 100 is a mobile wireless communication apparatus. The UE 100 may be any apparatus as long as the UE 100 is used by a user. Examples of the UE 100 include a mobile phone terminal (including a smartphone) and/or a tablet terminal, a notebook PC, a communication module (including a communication card or a chipset), a sensor or an apparatus provided on a sensor, a vehicle or an apparatus provided on a vehicle (vehicle UE), and a flying object or an apparatus provided on a flying object (aerial UE).

The NG-RAN 10 includes base stations (referred to as “gNBs” in the 5G system) 200. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter simply referred to as a “frequency”).

Note that the gNB 200 can also be connected to an Evolved Packet Core (EPC) that is an LTE core network. An LTE base station (evolved Node B (eNB)) can also be connected to the 5GC 20. The LTE base station and the gNB 200 can also be connected via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF are connected to the gNB 200 via an NG interface which is an interface between a base station and the core network.

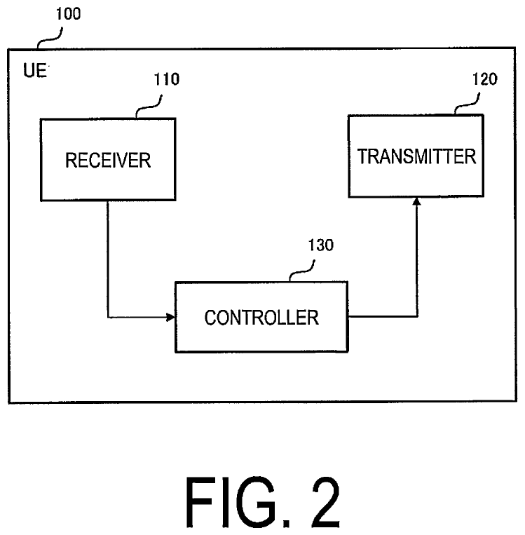

FIG. 2 is a diagram illustrating a configuration example of the user equipment 100 (UE) according to the first embodiment. The UE 100 includes a receiver 110, a transmitter 120, and a controller 130. The receiver 110 and the transmitter 120 constitute a wireless communicator that performs wireless communication with the gNB 200.

The receiver 110 performs various types of reception under control of the controller 130. The receiver 110 includes an antenna and a reception device. The reception device converts a radio signal received through the antenna into a baseband signal (a reception signal) and outputs the resulting signal to the controller 130.

The transmitter 120 performs various types of transmission under control of the controller 130. The transmitter 120 includes an antenna and a transmission device. The transmission device converts a baseband signal (a transmission signal) output by the controller 130 into a radio signal and transmits the resulting signal through the antenna.

The controller 130 performs various types of control and processing in the UE 100. Such processing includes processing of respective layers to be described later. The controller 130 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing. Note that the controller 130 may perform all processing or each operation in the UE 100 in each embodiment to be described below.

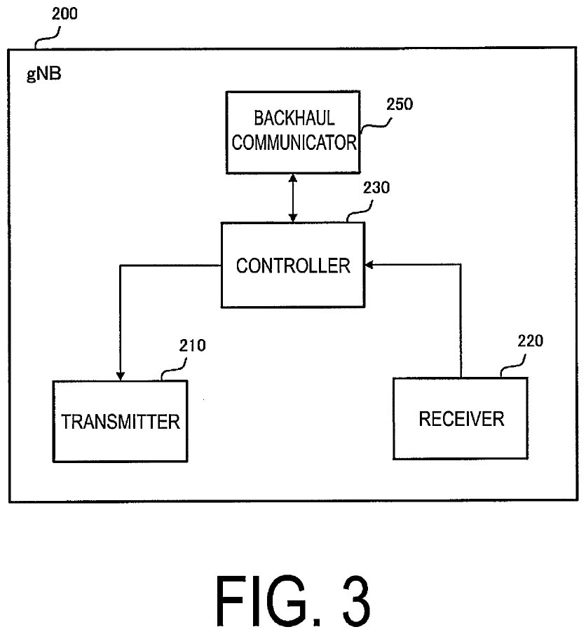

FIG. 3 is a diagram illustrating a configuration of the gNB 200 (base station) according to the first embodiment. The gNB 200 includes a transmitter 210, a receiver 220, a controller 230, and a backhaul communicator 240. The transmitter 210 and the receiver 220 constitute a wireless communicator that performs wireless communication with the UE 100. The backhaul communicator 240 constitutes a network communicator that performs communication with the CN 20.

The transmitter 210 performs various types of transmission under control of the controller 230. The transmitter 210 includes an antenna and a transmission device. The transmission device converts a baseband signal (a transmission signal) output by the controller 230 into a radio signal and transmits the resulting signal through the antenna.

The receiver 220 performs various types of reception under control of the controller 230. The receiver 220 includes an antenna and a reception device. The reception device converts a radio signal received through the antenna into a baseband signal (a reception signal) and outputs the resulting signal to the controller 230.

The controller 230 performs various types of control and processing in the gNB 200. Such processing includes processing of respective layers to be described later. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing. The controller 230 may perform all of the processing and operations in the gNB 200 in each embodiment to be described below.

The backhaul communicator 240 is connected to a neighboring base station via an Xn interface which is an inter-base station interface. The backhaul communicator 240 is connected to the AMF/UPF 300 via an NG interface between a base station and the core network. Note that the gNB 200 may include a Central Unit (CU) and a Distributed Unit (DU) (i.e., functions are divided), and both units may be connected via an F1 interface that is a fronthaul interface.

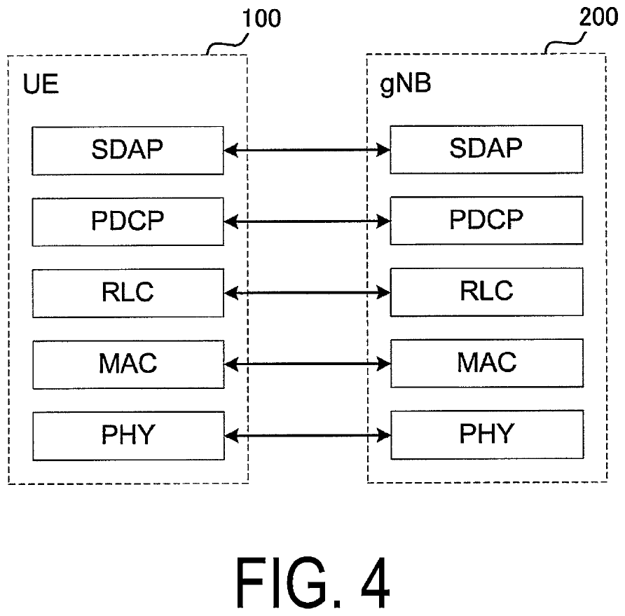

FIG. 4 is a diagram illustrating a configuration of a protocol stack of a radio interface of a user plane handling data.

A radio interface protocol of the user plane includes a physical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 blind decodes the PDCCH using a radio network temporary identifier (RNTI) and acquires successfully decoded DCI as DCI addressed to the UE 100. The DCI transmitted from the gNB 200 is appended with CRC parity bits scrambled by the RNTI.

The MAC layer performs priority control of data, retransmission processing through hybrid ARQ (HARQ: Hybrid Automatic Repeat reQuest), a random access procedure, and the like. Data and control information are transmitted between the MAC layer of the UE 100 and the MAC layer of the gNB 200 via a transport channel. The MAC layer of the gNB 200 includes a scheduler. The scheduler determines transport formats (transport block sizes, Modulation and Coding Schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between an IP flow as the unit of Quality of Service (QOS) control performed by a core network and a radio bearer as the unit of QoS control performed by an Access Stratum (AS). Note that, when the RAN is connected to the EPC, the SDAP need not be provided.

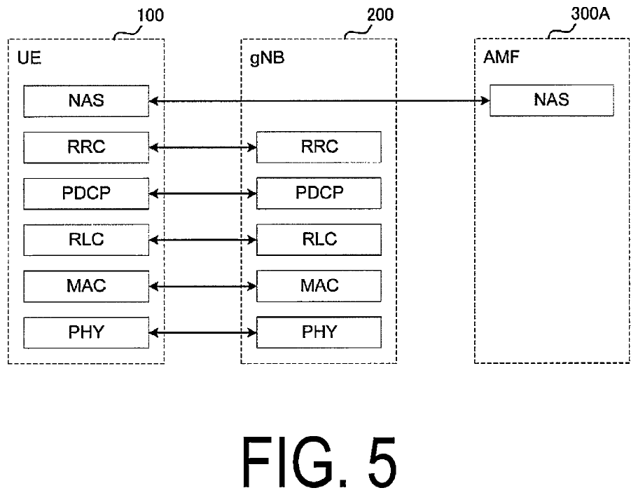

FIG. 5 is a diagram illustrating a configuration of a protocol stack of a radio interface of a control plane handling signaling (control signal).

The protocol stack of the radio interface of the control plane includes a Radio Resource Control (RRC) layer and a Non-Access Stratum (NAS) layer instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection (RRC connection) between the RRC of the UE 100 and the RRC of the gNB 200 is present, the UE 100 is in an RRC connected state. When no connection (RRC connection) between the RRC of the UE 100 and the RRC of the gNB 200 is present, the UE 100 is in an RRC idle state. When the connection between the RRC of the UE 100 and the RRC of the gNB 200 is suspended, the UE 100 is in an RRC inactive state.

The NAS, which is located above the RRC layer, performs session management, mobility management, and the like. NAS signaling is transmitted between the NAS of the UE 100 and the NAS of the AMF 300. Note that the UE 100 includes an application layer other than the protocol of the radio interface. A layer lower than the NAS is referred to as an Access Stratum (AS).

### UAV

An unmanned aerial vehicle (Unmanned Aerial Vehicle or Uncrewed Aerial Vehicle (UAV). An “unmanned aerial vehicle” may be referred to as a “UAV” below) according to the first embodiment is described.

The UAV is generally an unmanned aircraft, such as a drone. However, in the first embodiment, a UE positioned at an altitude equal to or higher than a predetermined threshold value (or exceeding the predetermined threshold value) is referred to as a UAV. The UAV may be a UE capable of performing wireless communication with the gNB 200 while flying in the sky in an unmanned manner like an unmanned aircraft. The UAV may be provided to an unmanned aircraft. The UAV may be provided to a manned aircraft. For example, a UE owned by a user on board of an aircraft, while the aircraft is flying at an altitude equal to or higher than a predetermined threshold value, may also be a UAV. The UAV may be a UAV UE. The UAV may be an Aerial UE. The UAV may be distinguished from a UE that is used on the ground. However, when not particularly distinguished from the UE, the UAV may be included in a UE as an example of the UE. In this case, the UAV and the UE may collectively be referred to as the UE. The configuration example of the UE 100 illustrated in FIG. 2 may represent a configuration example of the UAV.

In the 3GPP, a function for supporting an Aerial UE is defined as follows, for example.

First, an Aerial UE can report its altitude. For example, the Aerial UE can report the altitude when its altitude becomes equal to or higher than or equal to or lower than a threshold value. At this time, the Aerial UE can also report position information. The position information may also include a horizontal velocity and a vertical velocity of the Aerial UE.

Second, a network (E-UTRAN) of the LTE system can request the Aerial UE to report flight path information. The flight path information indicates a waypoint (passing point information or location point information) on a path of the Aerial UE. The flight path information may include a number of waypoints. The waypoint is represented as three-dimensional position information. The Aerial UE may report time information (time stamp) for each waypoint being included in the flight path information.

Third, a support availability for an Aerial UE (or whether to allow the UE to function as an Aerial UE) is included in subscription information for each user. The subscription information is stored for each user on a Home Subscriber Server (HSS) in the LTE system. The support availability for the Aerial UE is included in the subscription information. The subscription information is transmitted from the HSS to an eNB that is a base station in the LTE system under control of a Mobility Management Entity (MME). The eNB can recognize whether the UE is allowed to function as an Aerial UE.

Fourth, an event H1 and an event H2 can be used as a trigger condition for a measurement report. The event H1 represents an event condition when the altitude of the Aerial UE exceeds the threshold value. On the other hand, the event H2 represents an event condition when the altitude of the Aerial UE falls below the threshold value. These event conditions are each determined whether the condition is met by using a hysteresis value, an offset value, and a threshold value in addition to the altitude.

As described above, matters defined in the 3GPP are based on the assumption that the Aerial UE (i.e., the UAV) is used in the LTE system.

On the other hand, in the 3GPP, discussion on introduction of the UAV in NR (New Radio) has begun. With regard to the UAV, agreement has been made in the 3GPP. The agreement includes to use the above-mentioned event H1 and event H2, to report an altitude, a position, and a velocity of the UAV, to report a flight path plan, and the like.

### Terrestrial Cell and Sky Cell

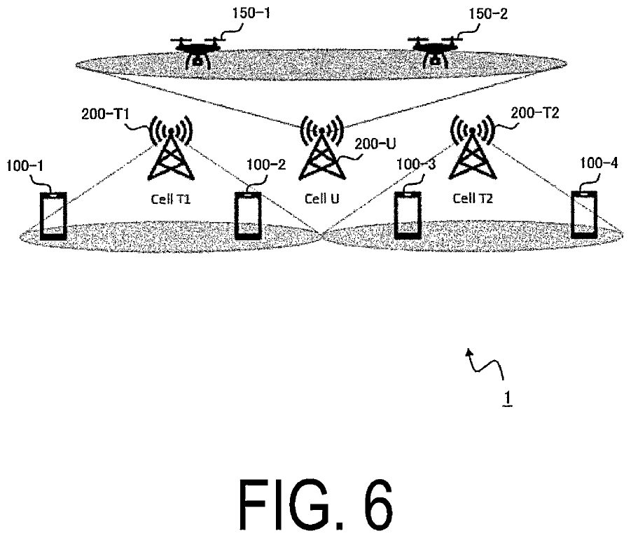

For example, it is assumed that a terrestrial cell and a sky cell coexist in a network. FIG. 6 is a diagram illustrating a cell configuration example of the case described above.

As illustrated in FIG. 6, a mobile communication system 1 includes terrestrial cells and a sky cell. In the example illustrated in FIG. 6, the terrestrial cells are constituted of a gNB 200-T1 and a gNB 200-T2, respectively, and the sky cell is constituted of a gNB 200-U. FIG. 6 illustrates an example in which UEs 100-1 to 100-4 each perform wireless communication with either the gNB 200-T1 or the 200-T2 in the terrestrial cell, and UAVs 150-1 and 150-2 each perform wireless communication with the gNB 200-U in the sky cell.

Here, in order for the UEs 100-1 to 100-4 to appropriately perform wireless communication in the terrestrial cells and in order for the UAVs 150-1 and 150-2 to appropriately perform wireless communication in the sky cell, the following two scenarios are assumed.

In the first scenario, a dedicated frequency is assigned to the sky cell, and different frequencies are used in the terrestrial cell and the sky cell. In the first scenario, for example, since wireless communication by the UAVs 150-1 and 150-2 and wireless communication by the UEs 100-1 to 100-4 is performed by using different frequencies, interference between the two wireless communications can be avoided.

On the other hand, in the second scenario, the same frequency (or the same frequency range) is used in the terrestrial cell and the sky cell. In the second scenario, since the frequency is shared by the terrestrial cell and the sky cell, frequency resources need not be specifically increased. Therefore, in the second scenario, effective use of frequency resources can be achieved.

### Communication Control Method According to First Embodiment

The first embodiment describes the UE 100 performing cell reselection in the sky. Typical (or legacy) cell reselection is described.

The cell reselection is performed when the UE 100 in the RRC idle state or the RRC inactive state migrates from a serving cell to a neighboring cell due to moving. More specifically, the UE 100 specifies a neighboring cell on which the UE needs to camp by the cell reselection procedure and reselects the specified neighboring cell. The serving cell and the neighboring cell may be managed by the same gNB 200. The UE 100 may be managed by the gNBs 200 different from each other. The cell reselection procedure is performed as follows, for example.

First, the UE 100 performs frequency-prioritization processing based on frequency-specific priorities specified by the gNB 200, for example, through an RRC release message. The frequency priority is higher as a numerical value thereof is lower, but the frequency priority may be lower as the numerical value thereof is higher.

Second, the UE 100 performs measures a radio quality for each of the serving cell and the neighboring cell. Details of the control is as follows. To be more specific, the UE 100 measures a received power and received quality (i.e., the radio quality) of a reference signal (e.g., a Cell Defining-Synchronization Signal and PBCH block (CD-SSB)) transmitted by each of the serving cell and the neighboring cell. The UE 100 measures always the radio quality for a frequency with a priority higher than the priority of the frequency of the current serving cell. On the other hand, for a frequency with a priority equal to or lower than the priority of the frequency of the current serving cell, when the radio quality of the current serving cell is lower than a predetermined quality, the UE 100 measures the radio quality for a frequency with a priority equal to or lower than the priority of the frequency of the current serving cell.

Third, the UE 100 reselects, based on the measurement result, a cell on which the UE 100 is to camp on. Details of the control is as follows. That is, when a priority of a frequency of a neighboring cell is higher than the priority of the current serving cell and the neighboring cell satisfies a predetermined quality standard (i.e., minimal required quality standard) for a predetermined period of time, the UE 100 may perform cell reselection to the neighboring cell. When the priorities of the frequencies of the neighboring cells are the same as the priority of the current serving cell, the UE 100 may rank the radio qualities of the neighboring cells, and perform cell reselection for the neighboring cells ranked higher than the ranking of the current serving cell for a predetermined period of time. When the priorities of the frequencies of the neighboring cells are lower than the priority of the current serving cell, the radio quality of the current serving cell is lower than a certain threshold, and the radio qualities of the neighboring cells are continuously higher than another threshold for the predetermined period of time, the UE 100 may perform cell reselection for the neighboring cell.

The above description is overview of the typical cell reselection procedure.

Here, consider that the sky cell and the terrestrial cell coexist in the network, as illustrated in FIG. 6. In such a case, when the UE 100 is located in the sky (i.e., the UAV 150), the sky cell is desirably reselected in the cell reselection procedure. On the other hand, when the UE 100 is located on the ground (i.e., located on the ground as a usual UE 100), the terrestrial cell is desirably reselected in the cell reselection procedure.

However, no mechanism is given in the current 3GPP for each of the terrestrial cell and the sky cell to be reselected for the UE 100 (or the UAV 150).

Therefore, the first embodiment aims at enabling the UE 100 to appropriately perform communication even in the sky by enabling the UE 100 to separately reselect the sky cell and the terrestrial cell.

Note that the 3GPP defines a High Speed Dedicated Network (HSDN) (e.g., 3GPP TS 38.304 V17.1.0 (2022 to 06)). In the HSDN, there is a cell called an HSDN cell. The UE 100 in a high mobility state (high-mobility state) can regard the HSDN cell as a cell of the highest priority. On the other hand, the UE 100 not in the high mobility state can regard the HSDN cell as a cell of the lowest priority. For example, the UE 100 moving with a high-speed railway can easily reselect the HSDN cell provided along the railway in preference to other cells. Therefore, the HSDN can appropriately support communication for the UE in the high mobility state.

However, the HSDN assumes that the UE 100 moves along the ground. Therefore, it is difficult to apply to the UAV 150 moving in an altitude direction (that is, moving up and down).

In the first embodiment, the user equipment (e.g., the UE 100) changes the frequency priority of the frequency used in the cell reselection procedure depending on an altitude of the user equipment. Therefore, for example, when the altitude of the UE 100 is equal to or higher than a predetermined value (or an altitude threshold value) (i.e., when the UE 100 is located in the sky), the frequency priority of the sky frequency can be taken as the highest priority. For example, when the altitude of the UE 100 is lower than the predetermined value (i.e., when the UE 100 is located on the ground), the frequency priority of the sky frequency can be also taken as the lowest priority. Here, the sky frequency is, for example, a frequency available to the UE 100 at the altitude equal to or higher than the predetermined threshold value. This allows, for example, the UE 100 when located in the sky to be more likely to reselect a neighboring cell (sky cell) supporting the sky frequency than the other cells in the cell reselection procedure. In contrast, the UE 100 located on the ground is less likely to reselect the sky cell than the other cells because the frequency is taken as the lowest priority. That is, the UE 100 located in the sky is more likely to reselect the sky cell than the terrestrial cell, and the UE 100 located on the ground is more likely to reselect the terrestrial cell than the sky cell. Therefore, the UE 100 can appropriately perform communication in the sky.

### Example of Operation According to First Embodiment

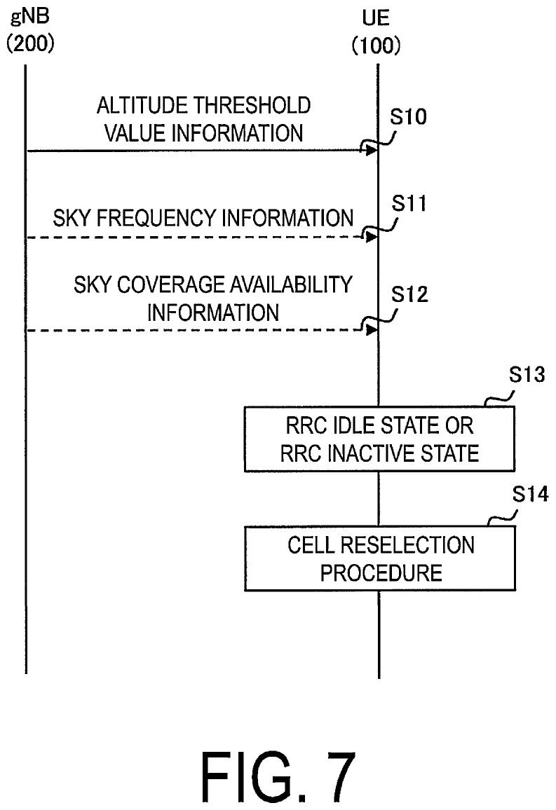

FIG. 7 is a diagram illustrating an operation example according to the first embodiment. Note that assume that the UE 100 before starting the operation is in an RRC connected state with respect to the serving cell.

In step S10, the gNB 200 transmits altitude threshold value information indicating a threshold value of the altitude (hereinafter, also referred to as an “altitude threshold value”). The altitude threshold value information may be broadcast using the system information (SIB). The altitude threshold value information may be transmitted to the UE 100 using an individual message (e.g., an RRC release (RRCRelease) message). The altitude threshold value may be a predetermined threshold value.

In the step S11, the gNB 200 may transmit sky frequency information indicating the sky frequency. The sky frequency may be a frequency available to the UE 100 (i.e., the UAV 150) flying at an altitude equal to or higher than the altitude threshold value. The sky frequency may be a neighboring frequency available in the neighboring cell (the sky cell). The sky frequency information may include a plurality of sky frequencies in a list format. In this case, each entry of the list may include an identifier indicating that the corresponding frequency is for the sky. The gNB 200 may transmit sky cell information indicating a cell supporting the sky frequency (that is, a sky cell) (or a neighboring cell supporting the sky frequency). The sky cell may be a cell formed at the altitude equal to or higher than the altitude threshold value. Alternatively, the sky cell may be a cell that provides a coverage formed at the altitude equal to or higher than the altitude threshold value. Alternatively, the sky cell may be a cell capable of communicating with the UE 100 (i.e., the UAV 150) flying at the altitude equal to or higher than the altitude threshold value. Alternatively, the sky cell may be a cell optimized for communication with the UE 100 (i.e., the UAV 150) flying at the altitude equal to or higher than the altitude threshold value. The sky cell information may include a cell ID of the sky cell. The sky cell information may similarly include a plurality of sky cells in a list form and may include an identifier indicating that the corresponding cell is for the sky. The gNB 200 may transmit the sky frequency information and/or the sky cell information. The sky frequency information and the sky cell information may be transmitted separately or may be combined into one piece of information and transmitted. The sky frequency information and the sky cell information may be transmitted in broadcast using the system information (SIB) or may be transmitted to the UE 100 using an individual message (e.g., an RRC release message).

In step S12, the gNB 200 may transmit a notification that the gNB 200 is capable of communication in the sky. For example, the gNB 200 may transmit sky coverage communication possibility information indicating that communication to the UE 100 having an altitude equal to or higher than the predetermined altitude is possible. Alternatively, the gNB 200 may transmit sky coverage communication availability information indicating whether communication to the UE 100 having the altitude equal to or higher than the altitude threshold value is available. Alternatively, the gNB 200 may transmit the sky coverage communication availability information indicating whether the coverage is provided to the UE 100 that is at the altitude equal to or higher than the altitude threshold value. The sky coverage communication possibility information (and the sky coverage communication availability information) may be transmitted in broadcast using the system information (SIB). The information may be transmitted to the UE 100 using an individual message (e.g., an RRC release message). The UE 100 may recognize, when receiving the sky coverage communication possibility information from the serving cell, that the frequency used in communication with the serving cell is the sky frequency.

The UE 100 may grasp the sky frequency (and/or the sky cell) and a terrestrial frequency (and/or the terrestrial cell) in step S11 and step S12.

In step S13, the UE 100 transitions from the RRC connected state to the RRC idle state or the RRC inactive state.

In step S14, the UE 100 performs the cell reselection procedure. For example, the UE 100 performs the following processing.

First, the UE 100 determines the altitude of the UE 100 based on the altitude threshold value (step S10). For example, the UE 100 determines “sky (or high altitude)” when its altitude is equal to or higher than (or exceeds) the altitude threshold value and determines “ground (or low altitude)” when its altitude is lower (or is equal to or lower) than the altitude threshold value. The altitude of the UE 100 may be measured by a sensor provided to the UE 100. The altitude of the UE 100 may be measured by a distance sensor (radar, lidar, or the like) provided to the UE 100. Note that the altitude may be represented in sea level. The altitude may be represented in elevation. The altitude may be represented in height from the ground.

Second, the UE 100 changes the frequency priority of the frequency used in the cell reselection depending on the altitude. For example, the UE 100 changes, when its altitude is “sky”, the sky frequency (step S11) to be the highest priority. Alternatively, the UE 100 may change, when its altitude is “sky”, the sky cell (step S11) supporting the sky frequency to be the highest priority. On the other hand, the UE 100 changes, when its altitude is “ground”, the sky frequency (step S11) to be the lowest priority. Alternatively, the UE 100 may change, when its altitude is “ground”, the sky cell (step S11) supporting the sky frequency to be the lowest priority.

Third, the UE 100 performs the cell reselection procedure using the frequency (or the cell) of which priority has changed depending on the altitude.

As a result, the UE 100, when located in the “sky”, can perform the cell reselection procedure by regarding the sky frequency as the highest priority. The UE 100 located in the “sky” may perform the cell reselection procedure by regarding the sky cell as the highest priority. That is, the UE 100 can perform the cell reselection procedure by regarding the sky frequency and/or the sky cell as the highest priority. Therefore, in the cell reselection procedure, the UE 100 may be more likely to reselect the sky cell supporting the sky frequencies than other neighboring cells (terrestrial cells), and thus can be more likely to camp on the sky cell.

On the other hand, the UE 100, when located on the “ground”, can perform the cell reselection procedure by regarding the sky frequency as the lowest priority. The UE 100 located on the “ground” may perform the cell reselection procedure by regarding the sky cell as the lowest priority. That is, the UE 100 can perform the cell reselection procedure by regarding the sky frequency and/or the sky cell as the lowest priority. Therefore, in the cell reselection procedure, the UE 100 may be more likely to reselect the other neighboring cells (terrestrial cells) than the sky cell, and thus can be more likely to camp on the terrestrial cell.

### Second Embodiment

A second embodiment will be described. The second embodiment mainly describes differences from the first embodiment.

The first embodiment has described two layers “ground” and “sky” concerning the altitude. However, the present disclosure is not limited thereto. The second embodiment describes the altitudes for three or more layers. Even in such a case, the UE 100 when located in each layer (or each altitude) of three or more layers can also perform the cell reselection procedure by regarding a frequency available in each layer as the highest frequency priority.

Accordingly, when the UE 100 located in each layer performs the cell reselection procedure, the UE 100 is likely to reselect a cell supporting a frequency corresponding to each altitude and camp on the cell. Therefore, the UE 100 can appropriately communicate with the sky cell by using the sky frequencies.

### Operation Example According to Second Embodiment

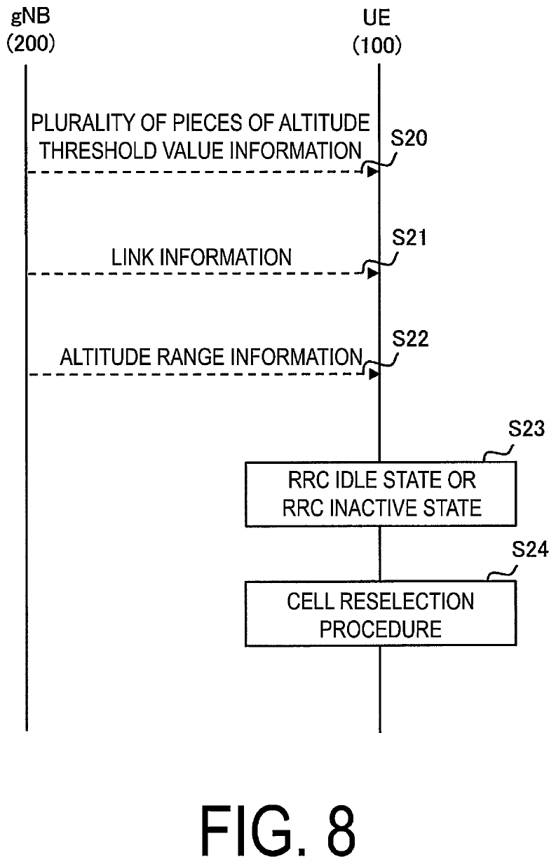

FIG. 8 is a diagram illustrating an operation example according to the second embodiment. In in FIG. 8 also, assume that the UE 100 before the start of the operation is in the RRC connected state with respect to the serving cell.

As illustrated in FIG. 8, in step S20, the gNB 200 may transmit a plurality of pieces of altitude threshold value information. For example, when the gNB 200 transmits three pieces of altitude threshold value information (altitude threshold value A1, altitude threshold value A2, and altitude threshold value A3), four layers can be configured, each corresponding to an altitude that is lower than the altitude threshold value A1, an altitude that is equal to or higher than the altitude threshold value A1 and lower than the altitude threshold value A2, an altitude that is equal to or higher than the altitude threshold value A2 and lower than the altitude threshold value A3, and an altitude that is equal to or higher than the altitude threshold value A3. The gNB 200 can configure three layers of altitudes by transmitting two pieces of altitude threshold value information, and may configure five layers of altitudes by transmitting four pieces of altitude threshold value information. The gNB 200 may transmit a plurality of pieces of altitude threshold value information depending on the number of layers of altitudes. The altitude threshold value information may represent a range of the altitudes. For example, for four layers, “−∞ to A1”, “A1 to A2”, “A2 to A3”, and “A3 to ∞” may be represented as the plurality of pieces of altitude threshold value information. Note that a plurality of altitude threshold values may be included in one piece of altitude threshold value information in a list format.

In the step S21, the gNB 200 may transmit link information between each altitude threshold and the frequency available at each altitude (or the cell supporting the frequency). That is, the gNB 200 may transmit the link information between each of the plurality of altitude threshold values and one of the frequency available depending on each altitude and the cell supporting the frequency. For example, transmitted is the link information between the altitude threshold value A1 and a frequency f1 available at an altitude lower than the altitude threshold value A1 (or a cell #1 supporting the frequency f1), and transmitted is the link information between the altitude threshold value A2 and a frequency f1 available at an altitude equal to or higher than the altitude threshold value A2 and lower than the altitude threshold value A2 (or a cell #2 supporting the frequency f2). In order to allow the gNB 200 to transmit such link information, the gNB 200 may transmit the sky frequency information (step S11 in FIG. 7) as in the first embodiment. In this case, the altitude threshold may be associated with the sky frequency information in the entry of each sky frequency (and/or the sky cell). The sky frequency information may include neighboring frequency information as frequency information related to the terrestrial frequency (or the terrestrial cell) other than the sky frequency (or the sky cell), and also in this case, may be associated with the altitude threshold value information. The sky frequency information may include link information for a link between the frequency (and/or the cell) and the altitude threshold value information. The gNB 200 may transmit the link information included in the sky frequency information. Note that the link information may be transmitted using the system information (SIB). The link information may be transmitted using individual signaling (e.g., an RRC release message).

In step S22, the gNB 200 may transmit altitude range information related to an altitude range supportable by itself (or the serving cell). The gNB 200 may transmit the altitude range information using the system information (SIB). The gNB 200 may transmit the altitude range information using individual signaling (e.g., an RRC release message.

In step S23, the UE 100 transitions to the RRC idle state or the RRC inactive state.

In step S24, the UE 100 determines its altitude and determines a frequency priority based on the determined altitude to perform the cell reselection procedure. For example, the UE 100 performs the following processing.

First, the UE 100 determines the altitude of the UE 100 based on the plurality of pieces of altitude threshold value information (step S20). The UE 100 determines, based on its altitude measured by the sensor and each piece of the altitude threshold value information, at which of the altitudes of the three or more layers the UE 100 is located. In this case, the UE 100 may express its altitude as an altitude state. For example, the UE 100 may determine the altitude state as “ground” when its altitude is lower than the altitude threshold value A1, determine the altitude state as “low altitude” when its altitude is equal to or higher than the altitude threshold value A1 and lower than the altitude threshold value A2, determine the altitude state as “medium altitude” when its altitude is equal to or higher than the altitude threshold value A2 and lower than the altitude threshold value A3, and determine the altitude state as “high altitude” when its altitude is equal to or higher than the altitude threshold value A3.

Second, the UE 100 changes the corresponding frequency (or the cell) to be the highest priority depending on its altitude. For example, the UE 100 changes the frequency that is available with the altitude threshold value lower than the altitude threshold value A1 to be the highest frequency priority when its altitude is lower than the altitude threshold value A1, changes the frequency that is available with the altitude threshold value equal to or higher than the altitude threshold value A1 and lower than the altitude threshold value A2 to be the highest frequency priority when its altitude is equal to or higher than the altitude threshold value A1 and lower than the altitude threshold value A2, and the like. When the relationship between the altitude threshold value and the frequency available at each altitude is transmitted as the link information to the UE 100 (step S21), the UE 100 can grasp the altitude threshold value used in determining its altitude and the frequency associated with the altitude threshold value by using the link information. When the sky frequency information is transmitted, since the relationship between each frequency and the altitude threshold value is indicated in each list, the UE 100 can grasp the altitude threshold value used for the altitude determination and the frequency corresponding to the altitude threshold value by using the sky frequency information. Then, the UE 100 changes the frequency to be the highest priority.

Third, the UE 100 performs the cell reselection procedure using the frequency (or the cell) of which priority has changed depending on the altitude.

As a result, the UE 100 can perform the cell reselection procedure depending on the altitude at which the UE 100 is located, regarding the frequency available at that altitude as the highest priority. The UE 100 can reselect a cell corresponding to each altitude and perform communication with the cell.

### Third Embodiment

Next, a third embodiment will be described. The third embodiment also mainly describes differences from the first embodiment.

The second embodiment has described the example in which the link information between the altitude (or the altitude threshold value) and the frequency is transmitted. The third embodiment describe an example in which the link information between the altitude (or the altitude threshold value) and the frequency priority is transmitted.

To be more specific, first, the base station (for example, the gNB 200) transmits the frequency priority depending on the altitude of the user equipment (for example, the UE 100). Second, the user equipment applies the frequency priority depending on the altitude of the user equipment to a frequency (for example, the frequency used for the cell reselection procedure). Accordingly, for example, the gNB 200 can set the frequency used for the sky frequency to the highest priority. Therefore, the UE 100 is likely to reselect the sky cell supporting the sky frequency in the cell reselection procedure and can appropriately communicate with the sky cell in the sky.

### Operation Example According to Third Embodiment

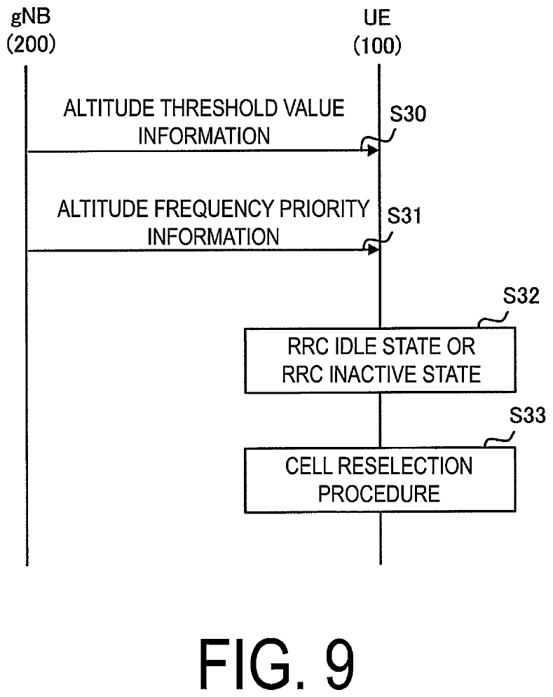

FIG. 9 is a diagram illustrating an operation example according to the third embodiment. In in FIG. 9 also, assume that the UE 100 before the start of the operation is in the RRC connected state with respect to the serving cell.

As illustrated in FIG. 9, in step S30, the gNB 200 transmits the altitude threshold value information. The altitude threshold value information may be the altitude threshold for identifying “ground” and “sky” as in the first embodiment. The altitude threshold value information may represent ranges of “ground” and “sky”. Alternatively, a plurality of pieces of altitude threshold value information may be transmitted as in the second embodiment.

In step S31, the gNB 200 transmits the altitude frequency priority information indicating the frequency priority, of the frequency used in the cell reselection, depending on the altitude (that is, the frequency priority for each altitude). The altitude frequency priority information may be broadcast using the system information (SIB). The altitude frequency priority information may be transmitted to the UE 100 using an individual message (e.g., an RRC release message). The frequency priority for each altitude may include the frequency priority depending on the altitude for each frequency as follows.

(X1) Frequency f1: the frequency priority for “ground” is “7”, and the frequency priority for “sky” is “0”.

(X2) Frequency f2: the frequency priority for “ground” is “1”, and the frequency priority for “sky” is “6”.

Alternatively, the frequency priority for each altitude may include the frequency priority for each frequency, for each altitude as follows.

(Y1) “Ground”: the frequency priority of the frequency f1 is “7”, and the frequency priority of the frequency f2 is “1”.

(Y2) “Sky”: the frequency priority of the frequency f1 is “0”, and the frequency priority of the frequency f2 is “6”.

The altitude state, described in the example of two layers of “ground” and “sky”, may include those for three layers (for example, “ground”, “low altitude”, or “high altitude”) or more, as in the second embodiment. Also in this case, in a manner similar to or the same as the case of two layers, the frequency priority for each layer (or each altitude) may be included in the altitude frequency priority information for each frequency (or the frequency priority of each frequency may be included in the altitude frequency priority information for each layer). Although the above-described example describes the altitude is represented by the altitude state of the UE 100 (for example, “ground” or “sky”), the present disclosure is not limited thereto. The altitude may be represented by the altitude range (e.g., “−∞ to A”, or “A to ∞”). Alternatively, the altitude may be represented by the altitude threshold value (for example, “lower than the altitude threshold A” corresponds to “ground” in the above-described example, and “equal to or higher than the altitude threshold A” corresponds to “sky” in the above-described example). The altitude frequency priority information may include information indicating that a conventional (or legacy) frequency priority is applied to the frequency priority for “ground” and a new frequency priority is applied to the frequency priority for “sky”. The altitude frequency priority information may be the link information that associates the altitude (or the altitude threshold value) with the frequency priority.

In step S32, the UE 100 transitions to the RRC idle state or the RRC inactive state.

In step S33, the UE 100 performs the cell reselection procedure. In the cell reselection procedure, the UE 100 applies the frequency priority depending on the altitude of the UE 100 to each frequency. For example, the UE 100 performs the following processing.

That is, the UE 100 measures its own altitude and compares it with the altitude threshold value information (step S30) to determine the altitude (or the altitude state) of the UE 100. Then, the UE 100 applies, based on the altitude frequency priority information, the frequency priority depending on its altitude to each frequency (step S31). For example, the UE 100 applies, when its altitude is “sky”, the frequency priority for “sky” to each frequency. For example, the UE 100 applies, when its altitude is “ground”, the frequency priority for “ground” to each frequency. The UE 100 performs the cell reselection procedure using the frequency to which the frequency priority is applied.

### Fourth Embodiment

A fourth embodiment will be described.

The fourth embodiment describes an example in which a tracking area code (TAC) for sky is transmitted. To be more specific, the base station (e.g., the gNB 200) transmits a tracking area code identifying a tracking area formed at an altitude equal to or higher than the altitude threshold.

As a result, for example, the UE 100 can perform the cell reselection procedure by regarding the frequency belonging to the TAC for sky as the highest frequency priority. Therefore, also in the fourth embodiment, the UE 100 can reselect the sky cell supporting the frequency and appropriately communicate with that cell.

When the UE 100 moves within the tracking area indicated by the sky TAC, the UE 100 may not need to transmit a location registration request (Tracking Area Update Request) message. Alternatively, when the UE 100 moves within a registration area indicated by one or more TACs for sky, the UE 100 may not need to transmit a registration request message. Therefore, the UE 100 can reduce power consumption as compared when the UE transmits each message every time it moves. The UE 100 transmits the location registration request (or the registration request) message to the network (e.g., the AMF 300) when the UE 100 enters the tracking area indicated by the sky TAC (or the registration area indicated by the sky TAC) or exits the tracking area indicated by the sky TAC (specifically, enters a tracking area for ground or a registration area for ground). Thus, the network (e.g., the AMF 300) can grasp whether the UE 100 is located in the sky or on the ground.

As described above, by providing the TAC for sky in addition to the TAC for ground, the UE 100 (i.e., the UAV 150) flying in the sky can appropriately communicate with the gNB 200.

### Operation Example According to Fourth Embodiment

An operation example according to the fourth embodiment will be described.

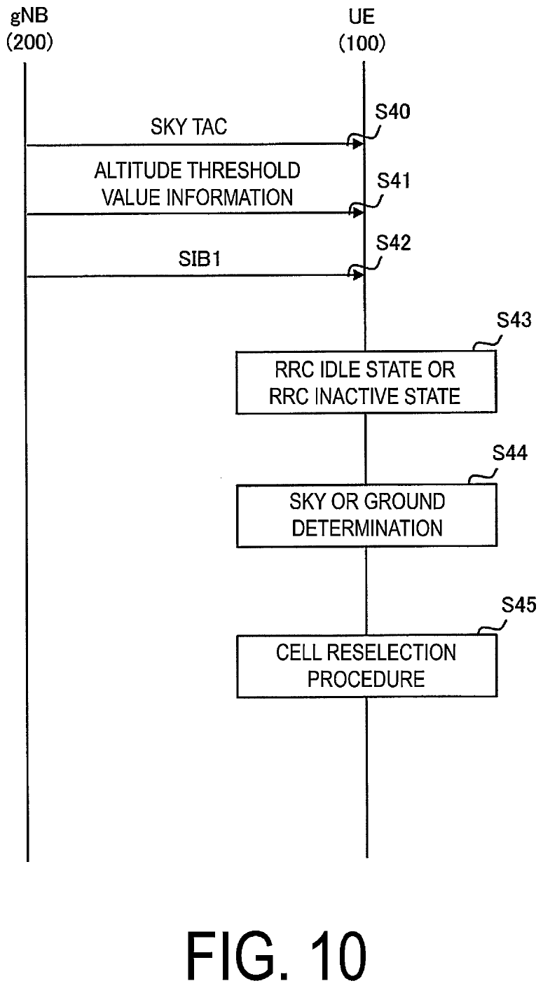

FIG. 10 is a diagram illustrating an operation example according to the fourth embodiment. Assume that the UE 100 is in the RRC connected state with respect to the serving cell before the operation illustrated in FIG. 10 is started.

As illustrated in FIG. 10, in step S40, the gNB 200 transmits the TAC identifying the tracking area formed at the altitude equal to or higher than the altitude threshold value (i.e., “sky”) (hereinafter, that TAC may be sometimes referred to as the “TAC for sky”). The TAC for sky is distinguished from the TAC to be used for the ground. There may be a plurality of TACs for sky. In this case, each TAC for sky can identify each of a plurality of divided tracking areas for sky. A registration area for sky may be formed at the altitude equal to or higher than the altitude threshold value. In this case, the registration area for sky may be configured by one or more TACs for sky. The sky TAC may be broadcast using the system information (SIB). The sky TAC may be transmitted to the UE 100 using an individual message (e.g., an RRC release message). Alternatively, the AMF 300 may transmit the sky TAC to the UE 100 using a NAS message. The gNB 200 may transmit a Public Land Mobile Network (PLMN) ID for sky. In this case, the PLMN ID for sky is distinguished from a PLMN ID for ground.

In step S41, the gNB 200 transmits the altitude threshold value information. The altitude threshold value information may be handed as in the first embodiment, or a plurality of pieces of altitude threshold value information may be transmitted as in the second embodiment.

In step S42, the gNB 200 transmits the system information (SIB1) The SIB1 includes TACs for the serving cell and the neighboring cell used for terrestrial use. The SIB 1 may include information related to the sky frequency (and/or the sky cell supporting the sky frequency) belonging to the sky tracking area. The information may include the sky TAC for identifying the sky tracking area in addition to the sky frequency (and/or the sky cell) belonging to the sky tracking area. The information may be transmitted to the UE 100 using an individual message (e.g., an RRC release message). Alternatively, the SIB1 may include information related to the sky frequency (and/or the sky cell) belonging to the PLMN for sky. The information may include the PLMN ID for sky identifying the PLMN for sky in addition to the sky frequency (and/or the sky cell) belonging to the PLMN for sky. The information may be also transmitted to the UE 100 using an individual message (e.g., an RRC release message).

In step S43, the UE 100 transitions to the RRC idle state or the RRC inactive state.

In step S44, the UE 100 determines the sky or the ground. The UE 100 may determine whether the UE 100 is located in the “sky” or on the “ground” based on the altitude measured using the sensors and the altitude threshold value information (step S41) as in the first embodiment and the like.

In step S45, the UE 100 performs the cell reselection procedure. The UE 100 may perform, when its altitude is equal to or higher than the altitude threshold (i.e., when located in the “sky”), the cell reselection procedure by regarding the sky frequency and/or the sky cells as the highest priority. To be more specific, the UE 100 grasps the sky frequency (or the sky cell) based on, for example, the sky TAC (step S40) and the sky frequency (or the sky cell) belonging to the sky TAC (step S42). Then, the UE 100 when located in the “sky” may perform the cell reselection procedure by regarding the sky frequency (or the sky cell) as the highest priority.

On the other hand, the UE 100 may perform, when its altitude is lower than the altitude threshold value, i.e., when located on the “ground”, the cell reselection procedure by regarding the sky frequency and/or the sky cell as the lowest priority. To be more specific, the UE 100 grasps the sky frequency (or the sky cell) based on, for example, the sky TAC (step S40) and the sky frequency (or the sky cell) belonging to the sky TAC (step S42). Then, the UE 100 when located on the “ground” may perform the cell reselection procedure by regarding the sky frequency (or the sky cell) as the lowest priority.

Note that the sky PLMN ID may be used in a PLMN selection procedure. That is, when the UE 100 recognizes that the UE 100 is located in the “sky” (or when the altitude of the UE 100 is equal to or higher than the altitude threshold value), the UE 100 may select the sky PLMN indicated by the sky PLMN ID by using the PLMN selection procedure. On the other hand, when the UE 100 recognizes that the UE 100 is located on the “ground” (or when the altitude of the UE 100 is lower than the altitude threshold value), the UE 100 may select a ground PLMN indicated by the ground PLMN ID by using the PLMN selection procedure.

### Other Embodiments

The operation flows described above can be separately and independently implemented, and also be implemented in combination of two or more of the operation flows. For example, some steps of one operation flow may be added to another operation flow or some steps of one operation flow may be replaced with some steps of another operation flow. In each flow, all steps may not be necessarily performed, and only some of the steps may be performed.

Although the example in which the base station is an NR base station (gNB) has been described in the embodiments and examples described above, the base station may be an LTE base station (eNB) or a 6G base station. The base station may be a relay node such as an Integrated Access and Backhaul (IAB) node. The base station may be a DU of the IAB node. The UE 100 may be a mobile termination (MT) of the IAB node.

The term “network node” mainly means a base station but may mean a core network apparatus or a part (CU, DU, or RU) of the base station.

A program causing a computer to execute each of the processing performed by the UE 100 or the gNB 200 may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM. Circuits for executing processing performed by the UE 100 or the gNB 200 may be integrated, and at least a part of the UE 100 and the gNB 200 may be implemented as a semiconductor integrated circuit (chipset, System on a chip (SoC)).

The phrases “based on” and “depending on/in response to” used in the present disclosure do not mean “based only on” and “only depending on/in response to” unless specifically stated otherwise. The phrase “based on” means both “based only on” and “based at least in part on”. The phrase “depending on” means both “only depending on” and “at least partially depending on”. The terms “include,” “comprise” and variations thereof do not mean “include only items stated” but instead mean “may include only items stated” or “may include not only the items stated but also other items”. The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a,” “an,” and “the” are added in the present disclosure through translation, these articles include the plural unless clearly indicated otherwise in context.

The embodiments have been described above in detail with reference to the drawings, but specific configurations are not limited to those described above, and various design variations can be made without departing from the gist of the present disclosure. All or some of the embodiments, operations, processes, and steps may be combined without being inconsistent.

### Supplements

### Supplementary Note 1

A communication control method in a mobile communication system, the communication method including
a step of changing, by a user equipment, a frequency priority of a frequency to be used in a cell reselection procedure depending on an altitude of the user equipment.

### Supplementary Note 2

The communication control method according to supplementary note 1, further including:
a step of transmitting, by a network node, altitude threshold value information indicating an altitude threshold value; and
a step of determining, by the user equipment, an altitude of the user equipment based on the altitude threshold value.

### Supplementary Note 3

The communication control method according to supplementary note 1 or 2, further including a step of transmitting, by the network node, sky frequency information indicating a sky frequency available at an altitude equal to or higher than the altitude threshold value and/or sky cell information indicating a sky cell supporting the sky frequency.

### Supplementary Note 4

The communication control method according to any one of supplementary notes 1 to 3, wherein
the step of changing includes, by the user equipment,
a step of performing the cell reselection procedure by regarding the sky frequency and/or the sky cell as a highest priority when the altitude of the user equipment is equal to or higher than the altitude threshold value and
a step of performing the cell reselection procedure by regarding the sky frequency and/or the sky cell as a lowest priority when the altitude of the user equipment is lower than the altitude threshold value.

### Supplementary Note 5

The communication control method according to any one of supplementary notes 1 to 4, further including
a step of transmitting, by a network node, sky coverage communication possibility information indicating that communication to the user equipment having an altitude equal to or higher than a predetermined threshold value is possible.

### Supplementary Note 6

The communication control method according to any one of supplementary notes 1 to 5, wherein
the step of transmitting altitude threshold value information includes a step of transmitting, by the network node, a plurality of pieces of the altitude threshold value information, and
the step of determining includes a step of determining, by the user equipment, an individual altitude of the user equipment based on each of the altitude threshold values.

### Supplementary Note 7

The communication control method according to any one of supplementary notes 1 to 6, further including
a step of transmitting, by the network node, link information between each of the plurality of altitude threshold values and one of the frequency available depending on the individual altitude and a cell supporting the frequency, wherein
the step of changing includes a step of changing, by the user equipment, one of the frequency depending on the altitude of the user equipment and the cell supporting the frequency to be a highest priority.

### Supplementary Note 8

The communication control method according to any one of supplementary notes 1 to 7, further including
a step of transmitting, by the network node, the frequency priority depending on the altitude of the user equipment for the frequency, wherein
the step of changing includes a step of applying, by the user equipment, the frequency priority depending on the altitude of the user equipment to the frequency.

### Supplementary Note 9

A communication control method in a mobile communication system, the communication method including
a step of transmitting, by a network node, a tracking area code identifying a tracking area formed at an altitude equal to or higher than an altitude threshold value.

### Supplementary Note 10

The communication control method according to supplementary note 9, further including: a step of transmitting, by the network node, one of a frequency belonging to the tracking area and a cell supporting the frequency;
by a user equipment,
a step of performing a cell reselection procedure by regarding the frequency belonging to the tracking area and/or the cell supporting the frequency as a highest priority when an altitude of the user equipment is equal to or higher than the altitude threshold value; and
a step of performing the cell reselection procedure by regarding the frequency belonging to the tracking area and/or the cell supporting the frequency as a lowest priority when the altitude of the user equipment is lower than the altitude threshold value.

1. A communication control method in a mobile communication system, the communication method comprising
changing, by a user equipment, a frequency priority of a frequency to be used in a cell reselection procedure depending on an altitude of the user equipment.

2. The communication control method according to claim 1, further comprising:
transmitting, by a network node, altitude threshold value information indicating an altitude threshold value; and
determining, by the user equipment, an altitude of the user equipment based on the altitude threshold value.

3. The communication control method according to claim 2, further comprising
transmitting, by the network node, sky frequency information indicating a sky frequency available at an altitude equal to or higher than the altitude threshold value and/or sky cell information indicating a sky cell supporting the sky frequency.

4. The communication control method according to claim 3, wherein
the changing comprises, by the user equipment,
performing the cell reselection procedure by regarding the sky frequency and/or the sky cell as a highest priority when the altitude of the user equipment is equal to or higher than the altitude threshold value and
performing the cell reselection procedure by regarding the sky frequency and/or the sky cell as a lowest priority when the altitude of the user equipment is lower than the altitude threshold value.

5. The communication control method according to claim 1, further comprising
transmitting, by the network node, sky coverage communication possibility information indicating that communication to the user equipment having an altitude equal to or higher than a predetermined threshold value is possible.

6. The communication control method according to claim 2, wherein
the transmitting altitude threshold value information comprises transmitting, by the network node, a plurality of pieces of the altitude threshold value information, and
the determining comprises determining, by the user equipment, an individual altitude of the user equipment based on each of the altitude threshold values.

7. The communication control method according to claim 6, further comprising
transmitting, by the network node, link information between each of the plurality of altitude threshold values and one of the frequency available depending on the individual altitude and a cell supporting the frequency, wherein
the changing comprises changing, by the user equipment, one of the frequency depending on the altitude of the user equipment and the cell supporting the frequency to be a highest priority.

8. The communication control method according to claim 2, further comprising
transmitting, by the network node, the frequency priority depending on the altitude of the user equipment for the frequency,
wherein
the changing comprises applying, by the user equipment, the frequency priority depending on the altitude of the user equipment to the frequency.

9. A communication control method in a mobile communication system, the communication method comprising
receiving, by a user equipment from a network node, a tracking area code identifying a tracking area formed at an altitude equal to or higher than an altitude threshold value.

10. The communication control method according to claim 9, further comprising:
transmitting, by the network node, one of a frequency belonging to the tracking area and a cell supporting the frequency;
by a user equipment,
performing a cell reselection procedure by regarding the frequency belonging to the tracking area and/or the cell supporting the frequency as a highest priority when an altitude of the user equipment is equal to or higher than the altitude threshold value; and
performing the cell reselection procedure by regarding the frequency belonging to the tracking area and/or the cell supporting the frequency as a lowest priority when the altitude of the user equipment is lower than the altitude threshold value.

11. A user equipment in a mobile communication system, the user equipment comprising:
a controller configured to change a frequency priority of a frequency to be used in a cell reselection procedure depending on an altitude of the user equipment.
